(19) United States
(12) Patent Application Publication
(10) Pub. No.: US 2010/0075184 A1
(43) Pub. Date: Mar. 25, 2010

(54) CARBON DIOXIDE DISSOLUTION AND C4+nM STATE CARBON RECYCLING DEVICE AND METHOD

(76) Inventors: Shu-Chin Chen, Ping Zhen City (TW); Tzu-Yu Chen, Ping Zhen City (TW); Pi-Sung Lin, Ping Zhen City (TW)

Correspondence Address: RABIN & Berdo, PC, 1101 14TH STREET, NW, SUITE 500, WASHINGTON, DC, 20005, US

(21) Appl. No.: 12/235,010

(22) Filed: Sep. 22, 2008

(51) Int. Cl. H01M 8/04

(52) U.S. Cl. 429/17; 429/20

(57) ABSTRACT

With this technology, we build a nano-material which is structured as a tree with the branches and leaves being tentacles. When the temperature is between 150° C. and 180° C., those tentacles will shape themselves into nanometer holes to catch ion.

The chemical equation: uv+CO₂+ΔnM+2H₂+4e⁻↑→C+2H₂O+∇nM+4e⁻↓.

Those two chemical equations have one common subject, that's they both take high energy light particles to break the electron bond between carbon and oxygen, thus, the invertor can reduce the greenhouse gases (CO₂) in the atmosphere or recycle carbon from industrial emissions.

### BACKGROUND OF THE INVENTION

1. Field of the Invention

In the past two centuries, petrochemical energy have been used extensively to support industrial and technological developments, and some people called the civilization in these two centuries as the civilization of carbon or the era of carbon. The extensive use of petrochemical energy causes an adverse effect of producing increasingly large quantity of greenhouse gases including carbon dioxide in the atmosphere. The production of greenhouse gases is increased from 280 ppm. (in 1800) to approximately 380 ppm (at present). If we continue using petrochemical energy without controlling the production of greenhouse gases including carbon dioxide, the concentration of greenhouse gases including carbon dioxide will exceed 500 ppm and up to a dangerous level by the middle of this century (around 2050), and the world cannot bear such a high level of greenhouse gases.

According to reports from media, experts from major member countries of the united nation held a meeting at Bali island and forged into an agreement about climate change in December of 2007, in hope of controlling the concentration of greenhouse gases including carbon dioxide on earth below 440 ppm. before 2050, which implies that people have to reduce the discharge of greenhouse gases including carbon dioxide by approximately 30% everyday in the coming half century without affecting our economical development and life quality. In view of the description above, we have to invest tremendously for huge constructions to reduce the volume of carbon dioxides and other greenhouse gases, but there is only one earth, and it is our responsibility to save the living organism on earth.

The carbon dioxide decomposition and recycle device in accordance with the present invention uses a nanometer-scale synaptic conductive structure (nM), whose appearance has floppy synaptic tentacles, and these tentacles are tangled to form nanopores at a temperature of 150° C.˜180° C. and the nanopores can capture carbon ions to form C⁴⁺ nM state carbon. When the temperature drops to 90° C.˜30° C., the tangled nanometer tentacles resume their floppy synaptic state and release carbon (C) particles reduced from the C⁴⁺ nM state carbon, and then wait for the next heating for performing another cycle, and the present invention uses three wonderful characteristics including compensatory characteristic, temperature change control characteristic and contractible mechanical characteristic of the electrons of this nanometer structure (nM) to break the secured chemical carbon-oxygen bond in carbon dioxide. Manufacturing processes at different stages are used for creating the world's first carbon dioxide decomposition and recycle device. In addition to the decomposition of carbon dioxide and the recycle of carbon (C) and water (H₂O), the present invention also can provide the function of a fuel cell to compensate the energy consumption required for the decomposition and recycle of carbon dioxide, and a nanometer-scale carbon with a high purity can be achieved.

2. Description of the Related Art

Although the prior art can temporarily absorb and restrict carbon dioxide in a certain specific material sodium hydroxide (NaOH) with a reaction formula of NaOH+CO₂→NaHCO₃, such reaction cannot continue when the absorption of carbon dioxide in the material is saturated, and this situation is similar to the one encountered by the American spaceship Apollo 13. Thus, the use of a specific material to absorb carbon dioxide can process a certain concentration of carbon dioxide, but such application is not valuable to the construction of reducing a large quantity of carbon dioxide or other greenhouse gases. Recently, the photosynthesis by cyanobacteria is attempted to deal with the high concentration of carbon dioxide discharged by factories, but cyanobacteria provides a limited efficiency due to the effects of sunlight, temperature and photosynthesis, and this arrangement requires tremendous land area, and thus becoming a bottleneck of its implementation, and it is definitely not the best way of reducing greenhouse gases.

### SUMMARY OF THE INVENTION

It is a primary objective of the present invention to provide a carbon dioxide decomposition and recycle method, which is the first concept of achieving the effect of decomposing carbon dioxide and strengthening electron bonds by industrial processes, and can be held at all weather conditions. Compared with the mechanism adopting the photosynthesis of plants to consume carbon dioxide, this method has a high efficiency more than twice of the photosynthesis mechanism and a pollution-free feature without any limitation on scale or district difference. For instance, the present invention can be applied in deserts, on seas, at north and south poles or underground caves without any limitation. Unlike the photosynthesis of plants, sunlight, temperature, cloud thickness and smog must be taken into consideration.

For a long time, the inventors of the present invention have been looking for a method capable of decomposing carbon dioxide (CO₂) into carbon (C) and oxygen (O₂), but hardly found any appropriate tool and fell into a professional blind spot and insisted on the belief that the electron bond between carbon and oxygen of carbon dioxide molecules is very strong chemical structure that cannot be broken, and thus the innovative idea has been put aside until now. All in a sudden, the inventors discovered that the carbon dioxide dissociation mechanism derived from the photosynthesis with a chemical formula 6CO₂+6H₂O→C₆H₁₂O₆+6O₂ existed in trillion of years can decompose carbon dioxide into carbohydrate (C₆H₁₂O₆) and oxygen (O₂), and thus the inventors recognized that the electron bond between carbon and oxygen of carbon dioxide molecules is not unbreakable, and the fact resides on that people have not found a method that can effectively decompose carbon dioxide and solid carbon only. The inventors regained hopes and spared no effort to find a way of decomposing carbon dioxide into carbon (C) and oxygen (O₂), and finally found an important theory as follows. We are unable to decompose carbon dioxide like plants by photosynthesis only, but we can refer to the principle of photosynthesis of plants and use the quantum effect of the photocatalystic ultraviolet (uv) to consume the electrons in a “carbon-oxygen” bond of carbon dioxide, such that the free electrons enter into an external conductive circuit for the power-up effect of the fuel cell, so that carbon dioxide can be decomposed into C⁴⁺ nM state carbon and oxygen (O₂) temporarily. Since the electrons excited by the ultraviolet (uv) and separated from an orbital of the carbon dioxide bond will return to their original state of moving around the orbital (energy level) immediately after the power disappears, the decomposed C⁴⁺ nM state carbon and oxygen (O₂) are in a very unstable state and may combine to form a new bond again and resume the stable state of carbon dioxide (CO₂). Therefore, it is an important technical key point of the present invention to maintain the C⁴⁺ nM state carbon and detach the oxygen (O₂) to keep carbon and oxygen to form a bond again.

With the description above, the present invention adopts a two-stage method for decomposing the tough “carbon-oxygen” electron bond of carbon dioxide, such that C⁴⁺ nM state carbon and oxygen (O₂) of carbon dioxide (CO₂) are decomposed, uv+CO₂+ΔnM→C⁴⁺ nM+O₂+4e⁻↑, and the oxygen (O₂) at the ionic state is combined with proton (H⁺) ionized from the hydrogen fuel cell (H₂ Fuel Cell) to form water (H₂O). The extra four free electrons (4e⁻) are consumed by an external circuit as shown in the chemical reaction formula O₂+4H⁺+4e⁻→2H₂O to force oxygen to recombine with C⁴⁺ nM state carbon to form a bond, and thus temporarily keeping the carbon ions (C⁴⁺) into the nanopores tangled by the nanometer tentacles to form C⁴⁺ nM state carbon and wait for a second stage to reduce the C⁴⁺ nM state carbon back to carbon, and its chemical reaction formula is C⁴⁺ nM+4e⁻↓→C+∇nM.

The present invention is the first to use high-energy particles (photons) emitted from ultraviolet (uv) to randomly bombard (excite) electrons at the outer surrounding of carbon dioxide (CO₂) to force the energy level of the electron bond of carbon dioxide from a base state to an excited state, such that the “carbon-oxygen” bond between atoms opens a quantum tunnel to release four free electrons (4e⁻) of carbon dioxide, and the four electrons (4e⁻) are deviated from the original orbital to move freely, which is called a quantum effect. The quantum effect weakens the bonding force of the carbon dioxide bond of the four free electrons (4e⁻), and carbon dioxide is converted temporarily into C⁴⁺ nM state carbon and ionic oxygen, and the power of the four free electrons (4e⁻) from the deviated orbital is forcibly consumed by the external circuit, and the energy level of the C⁴⁺ nM state carbon is situated at the base state when the free electrons (4e⁻) are lost. Now, the ionized oxygen (O₂) is combined with the four protons (H+) to form a bond, and the four free electrons (4e⁻) obtained from an external electronic circuit for filling the electric holes are reacted to form water (2H₂O) with a chemical reaction formula O₂+4H⁺+4e⁻→2H₂O. Oxygen (O₂) cannot be combined with the carbon ions (C⁴⁺) limited in the tangled nanopores to form a bond. Now, the carbon ions (C⁴⁺) have lost four free electrons (4e⁻) and combined with nanometer tentacles with less static electricity force and existed in the form of C⁴⁺ nM state carbon, and the energy level is resumed to the base state. We use a hydrogen fuel cell (H₂ Fuel Cell) to provide four protons (H⁺) to oxygen (O₂) produced by a carbon dioxide pole (CO₂ pole), so as to successfully decompose carbon dioxide into C⁴⁺ nM state carbon, and react the ionic oxygen (O₂) with the four protons (H⁻) into water (2H₂O), and the reaction process is shown by the following chemical equation:

(H₂ pole) 2H₂→4H⁺+4e⁻

(CO₂ pole) uv+CO₂+ΔnM→C⁴⁺ nM+O₂+4e⁻↑

(H₂O pole) O₂+4H⁺+4e⁻→2H₂O

The continuous supplementary reaction between the hydrogen fuel cell and the carbon dioxide pole taken place at the voltage and the current of the external dual electron circuit can be recycled and used easily for supporting the consumption for other applications, and the process for four protons (H⁺) and oxygen (O₂) to be reacted to form water (H₂O) will release heat energy which can be used for different applications through a thermal conducting material, and the heat energy is recycled and conducted to a carbon dioxide nanometer (nM) reacting pole, and thus greatly reducing the power consumption required when the temperature of the carbon dioxide nanometer (nM) reacting pole is increased. In other words, if the output capability of a dual-loop fuel cell drops to a rated 80%, it shows that the performance of the carbon dioxide pole (CO₂ pole) drops because the nanopores are filled up with the C⁴⁺ nM state carbon. It is necessary to have a second-stage chemical reaction which is the reduction process of the C⁴⁺ nM state carbon, wherein a static charge generator is used for returning the energy of the four electrons (4e⁻) to the reverse reaction process of the C⁴⁺ nM state carbon, and its chemical reaction equation is given below:

C⁴⁻ nM+4e⁻↓→C+∇nM.

In the process of the chemical reaction equation C⁴⁻ nM+4e⁻↓→C+∇nM, the energy of the four electrons (4e⁻) of the C⁴⁺ nM state carbon increased in the nano tangle frees us from the limitation of the static electricity force of the nano tangle. Meanwhile, the temperature of the nanometer structure drops from 150° C.˜180° C. at the tangled state to 90° C.˜30° C., such that the nano tangle tentacles resume their floppy synaptic state to facilitate the reduction to particulate carbon (C) and free from the limitation of the nano tangles. The nanometer structure resumes its original function and state, and waits for another cycle of heating and reuse.

An insulating osmosis membrane is installed between a carbon dioxide pole (CO₂ pole) of the dual loop fuel cell and a hydrogen pole (H₂ pole) of the hydrogen fuel cell for the separation, and assembled with a hydrogen reacting pole having the water (H₂O) reduction function to form a dual loop fuel cell. Two conductive circuits installed externally to the dual loop fuel cell drive the hydrogen pole (H₂ pole) and carbon dioxide pole (CO₂ pole) to catalyze and decompose the two hydrogen molecules (2H₂) and one carbon dioxide molecule (CO₂) to produce four free electrons (4e⁻), and consume the four free electrons in the power-up effect of each conductive circuit, such that the four free electrons (4e⁻) at excited state are deviated from the original orbital to fill each electric hole successfully to produce voltage and current.

Since the proton (H⁺) resolved from the hydrogen pole (H₂ pole) and the oxygen (O₂) resolved from the carbon dioxide pole (CO₂ pole) are penetrated through each insulating osmosis membrane, the protons and oxygen molecules are collided with each other at the hydrogen reacting pole to start the reduction process, and finally discharged in the form of water. In other words, O₂+4H⁺+4e⁻→2H₂O. The carbon dioxide without oxygen loses four free electrons (4e⁻) and exists in a form of C⁴⁺ nM state carbon stored between the tangled holes of the nanometer tentacles. The resolve/decompose effect of the carbon dioxide gas has similarities and differences with the photosynthesis of plants. Both rely on the quantum action force of the high-energy photons to bombard the electrons of the carbon dioxide bonding force from the original orbital to form free electrons and weaken the electron bonding force of the carbon dioxide. Both can resolve carbon temporarily, but a major difference resides on that plants do not need hydrogen ions to capture oxygen, but plants use chlorophyll to decompose water molecules by photosynthesis 6CO₂+6H₂O→C₆H₁₂O₆+6O₂, so that carbon and water are combined to form carbohydrate (C₆H₁₂O₆) and discharge oxygen directly, wherein the plants produces a resonance between the free electrons deviated from the orbital with the enzyme ATP such that carbon dioxide and water are combined to form carbohydrate and oxygen. The chlorophyll in the leaves of the plants synchronously produce resonance to a photosystem composed of chlorophyll α, chlorophyll β, carotenoids, small molecules and proteins, and different layers are used for consuming the energy of the free electrons to lower the energy level, so that the water is decomposed into hydrogen and oxygen, and hydrogen is further decomposed into proton and electron to synthesize a high-energy ATP and a reductant NADPH acted on the carbon dioxide molecules, and the carbon atoms in the carbon dioxide molecules are synthesized to form carbohydrate, so as to separate carbon and oxygen in carbon dioxide without requiring additional energy provided to the carbon ions. The carbon ions and water can be combined to form carbohydrate, and this is the skillful and efficient point of the evolution of plants. The present invention requires two stages to complete the decomposition of carbon dioxide and recycle carbon and water as shown in the equation below:

uv+CO₂+ΔnM+2H₂+4e⁻↑→C+2H₂O+∇nM+4e⁻↓.

Compared with the natural mechanism, the present invention cannot imitate the mechanism of photosynthesis to achieve the effect of fixing the carbon, but the invention can use the mechanism of photosynthesis to break the electron bonds of the carbon dioxide (CO₂). Therefore, the invention relates to a carbon dioxide (CO₂) resolve/decompose method and a reduction method of a non-biological mechanism, and the entire operation process does not involve any pollution, but gives the beneficial effect of recycled chemical energy and nanocarbon, which is an excellent solution for the greenhouse gases.

Since carbon dioxide comes with a strong bond, the methods in the past may be able to cut off the bonding force of carbon dioxide temporarily, the bond is resumed immediately afterward, and this is a difficult problem and a challenge to all experts in this field. If the materials adopted by these experts only have the characteristic of compensating the electron bond, the carbon dioxide cannot be actually decomposed into carbon and oxygen, because when the bonding force between carbon and oxygen is weakened, and no other force substitutes the original bonding force between carbon and oxygen, such as providing a new bond between proton (H⁺) and oxygen, the extra free electrons will be consumed, and the quantum state of the C⁴⁺ nM state carbon is situated at the base state temporarily, and oxygen will be combined with carbon in the C⁴⁺ nM state carbon immediately to form the stable carbon dioxide. With the compensation characteristic of the electron bond of the nanometer structure, the temperature change control characteristic and the flexibly changing mechanical characteristic in accordance with the present invention, the decomposition and recycle of carbon dioxide can be achieved. The photon resolve/decompose mechanism of the invention with non-biological features for industrial mass production is definitely a feasible solution for greenhouse gases. We can change the temperature of the nanometer structure easily to spread open the nano tangle tentacles filled with C⁴⁺ nM state carbon to successfully release carbon from the C⁴⁺ nM state carbon to for particulate carbon, so that the carbon dioxide pole (CO₂ pole) of the nanometer structure resumes its original shape to facilitate a reuse. The key point is to develop a carbon dioxide decomposition and recycle device in an industrial mass production scale without the limitations of volume and capacity. Any close space can be used for an installation, and the installed product can be as large as a football field or as small as a toaster.

The carbon dioxide decomposition and recycle device of the invention is prospective, and the presently known applications are listed below:

(1) A plurality of large carbon dioxide decomposition and recycle devices installed according to the present invention should be multi-linked devices and operating parallel in alternately. The devices can be installed at an exhaust outlet of a thermal power plant, a steel plant or a cement plant for removing electric charges and dusts, and rinsing the exhaust of high-concentration carbon dioxide, and effectively decomposing and recycling carbon dioxide into carbon and pure water. The invention provides a tool for protecting the environment and attempting to minimize carbon to zero. The key point of this application of the carbon dioxide decomposition and recycle device resides on the decomposition and recycle of carbon dioxide into carbon and pure water, and it becomes a beneficial tool for a certain company for protecting environment and reducing carbon. The buying party of carbon becomes a selling party who sells the reduced carbon quota to the industries such as airline, transportation, gas, and oil extraction industries that cannot reduce carbon technically. In addition to making additional profits, these companies also protect the environment. Of course, we cannot reduce carbon dioxide and greenhouse gases in the atmosphere to 280 ppm. of 1800 immediately, but we can effectively control carbon dioxide and greenhouse gases from rising. At present, our earth already has excessive carbon dioxide and greenhouse gases. Although the forests and coral in seas on earth can clean up the greenhouse gases, it may take a couple of centuries before a healthy earth is recovered. Without the assistance of the carbon dioxide decomposition and recycle device in accordance with the present invention, the construction and mission of reducing carbon dioxide and greenhouse gases on earth will be more difficult and time-consuming or require tens or hundreds of times of costs.

(2) A small carbon dioxide decomposition and recycle device in accordance with the present invention is installed in a manned spaceship, and uses the high-energy photons of the sunlight for electrolyzing water into hydrogen (H₂) and oxygen (O₂) as a fuel source of a CO₂ fuel cell. The invention carries on a constant filter cycle in a spaceship cabin for producing water used for the electrolysis by the optoelectric effect of the sunlight in order to prepare hydrogen and oxygen, wherein oxygen is provided for the respiration of astronauts, and hydrogen is provided for the use as a fuel for a hydrogen pole of the carbon dioxide decompose device (CO₂ fuel cell), and the concentration of carbon dioxide in the spaceship cabin will remain low due to the continuous operation of the carbon dioxide decomposition and recycle device. The carbon dioxide decomposition and recycle device of the present invention is primarily used for generating and supplying electric power to the spaceship cabin, and controlling the concentration of carbon dioxide, and both are equally important. Although the concentration of carbon dioxide in the spaceship cabin may not be too high, the device of the invention relates to operations of a constant cycle, thus, controlling the concentration of carbon dioxide in the spaceship cabin within a normal standard value effectively and naturally avoid accidents and risks during outer space missions. In other words, the carbon dioxide absorbing device in the Apollo 13 spaceship cabin prevents the recurrence of having a carbon dioxide concentration approaching a critical limit encountered by the astronauts, and also gives the additional benefit of a fuel cell.

(3) The mid-size carbon dioxide decomposition and recycle device produced in accordance with the present invention is installed in a military or civil submarine for assuring that the crews of the submarine can have sufficient oxygen for respiration without worrying about the high concentration of carbon dioxide. If an accident occurs in the submarine, the submarine installed with the mid-size carbon dioxide decomposition and recycle device will provide a longer waiting time for the rescue. In situation like this, the present invention will provide a precious life-saving tool for the crews of the submarine. The carbon dioxide decomposition and recycle device is applied for controlling the concentration of carbon dioxide.

(4) The carbon (C) recycled by the carbon dioxide decomposition and recycle device is nano-scale pure particulate carbon without any impurity, and the scope of its application is extensive, particularly used as a raw material for man-made diamonds. This application can greatly enhance the hit rate of the crystallization of man-made diamonds, lower the manufacturing cost, and improve the quality. The recycled nanocarbon can be used for manufacturing high-end carbon fibers as a premium material for manufacturing aircrafts or nanocarbon tubes or nanocarbon meshes used for fuel cell poles. The nanocarbon recycled by this device overcomes the yield rate issue of the carbon wafer fabrication process to expedite the development of the next-generation carbon wafer products and substitutes the current silicon wafer process that almost approaches the upper limit of Moore's Law and allows future information products produced by the carbon manufacturing process to have the light, handy, power-saving and quick functions.

### BRIEF DESCRIPTION OF THE DRAWINGS

FIG. 1 shows a carbon dioxide (CO₂) decompose device and its embodiment in accordance with the present invention; and

FIG. 2 shows a C⁴⁺ nM state carbon reducing device and its embodiment in accordance with the present invention.

### (1) COMPLETE CHEMICAL REACTION EQUATION

uv+CO₂+ΔnM+2H₂+4e⁻↑→C+2H₂O+∇nM+4e⁻↓

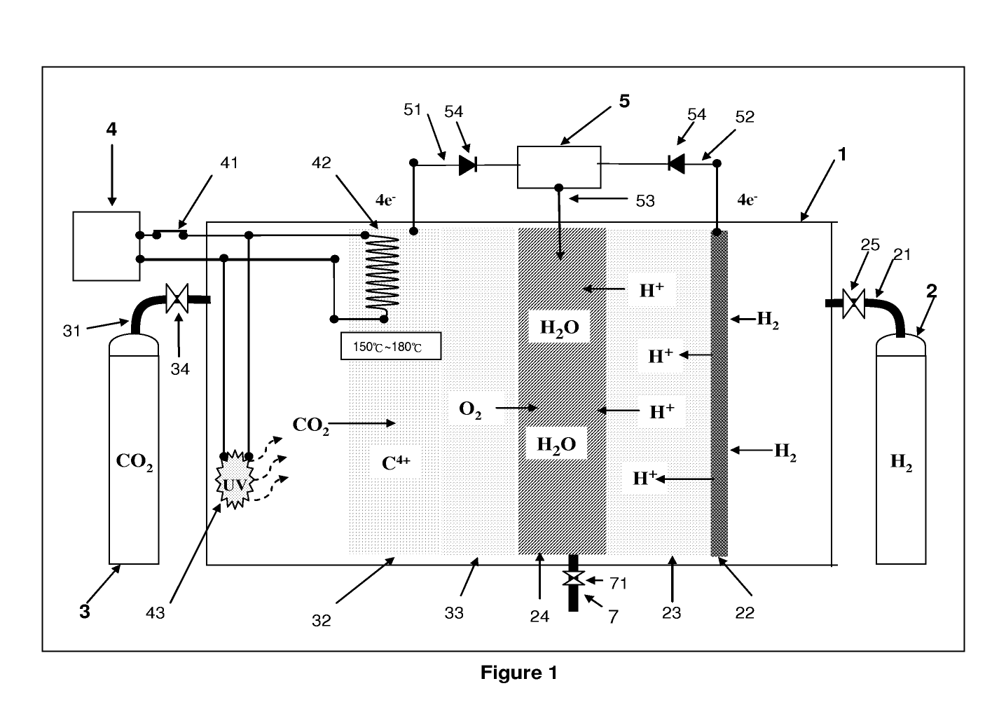

### (2) FIRST STAGE (DECOMPOSITION) REACTION EQUATION (REFER TO FIG. 1)

(CO₂ pole) uv+CO₂+ΔnM→C⁴⁺ nM+O₂+4e⁻↑

(H₂ pole) 2H₂→4H⁺+4e⁻

(H₂O pole) O₂+4H⁺+4e⁻→2H₂O

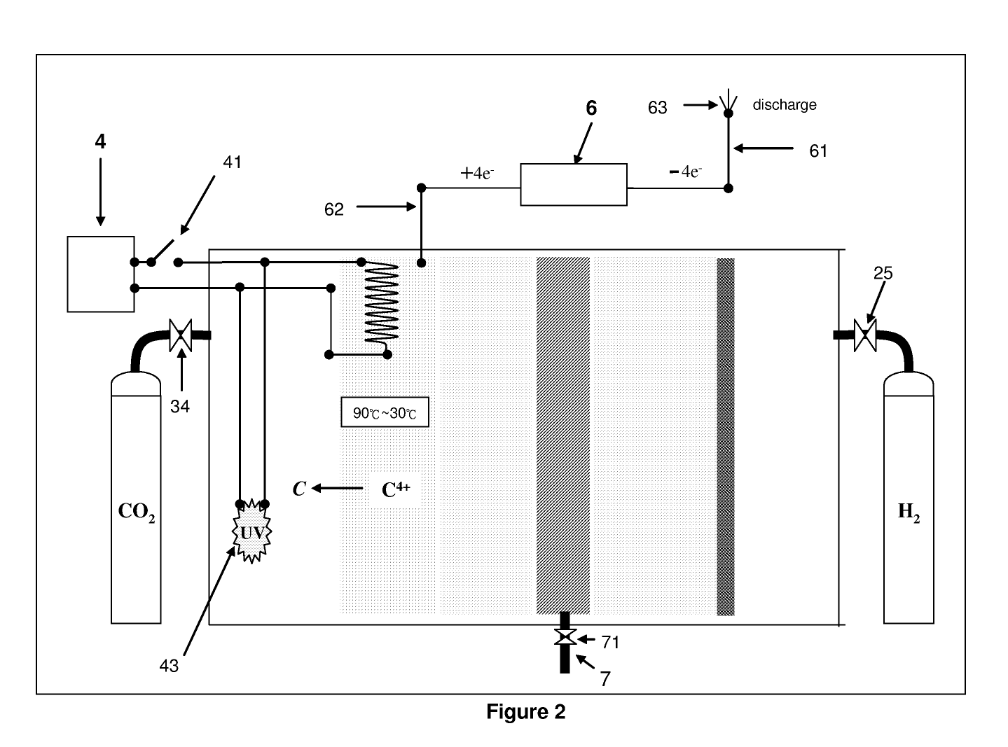

### (3) SECOND STAGE (REDUCTION) CHEMICAL REACTION EQUATION (REFER TO FIG. 2)

(CO₂ pole) C⁴⁺ nM+4e⁻↓→C+∇nM

Definition:

Nano materials: nM

Note: nM is a nanometer-scale synaptic conductive structure, whose appearance is a structure having a plurality of floppy synaptic tentacles, and these tentacles at the temperature of 150° C.˜180° C. are tangled to form nanopores for capturing the temporarily carbon ions separated from the electron bond of carbon dioxide to produce C⁴⁺ nM state carbon At the temperature of 90° C.˜30° C., the tangled nanometer tentacles resume their floppy synaptic form to release the carbon (C) particles reduced from the C⁴⁺ nM state carbon, and wait for the next heating for performing another cycle.

Ultraviolet light: uv

Electron: e⁻

Discharge: ↑

Charge: ↓

Temperature Rise: Δ

Temperature Drop: ∇

### DETAILED DESCRIPTION OF THE PREFERRED EMBODIMENTS

The present invention discloses a carbon dioxide decomposition and recycle device (CO₂ fuel cell ) using a traditional hydrogen fuel cell (H₂ Fuel Cell) as an anode structure for catalyzing four equivalences of protons (4H⁺) and four equivalences of electrons (4e⁻) produced by two hydrogen molecules (2H₂), and a carbon dioxide catalytic pole (CO₂ pole) is installed at an external side of a cathode of the fuel cell originally provides an interface of oxygen and serves as a generator of oxygen molecules (O₂). High-energy photons produced by the ultraviolet lamp is provides a quantum action force for breaking the bonding force between carbon and oxygen of carbon dioxide molecules and serves as a decomposition and catalysis driving force, such that carbon dioxide (CO₂) can be decomposed into C⁴⁺ nM state carbon and oxygen molecule (O₂) to produce four equivalences of electrons (4e⁻), and the oxygen molecule (O₂) decomposed from carbon dioxide (CO₂) is in line with a hydrogen pole (H₂ pole) for decomposing four equivalences of protons (4H⁺) and four equivalences of electron (4e⁻) to reduce to 2 water molecules (2H₂O).

With reference to FIG. 1, these components are assembled in close reaction space to form a dual loop fuel cell (1), and a hydrogen storage tank (2), a carbon dioxide storage tank (3), a power supply device (4), an electron loader (5) and a static charge generator (6) are installed on an external side of the dual loop fuel cell (1) to constitute a carbon dioxide decomposition and recycle device (CO₂ fuel cell) capable of decomposing carbon dioxide, reducing greenhouse gases, recycling nanometer-scale pure carbon and generating DC power.

In FIG. 1, a piece of carbon cloth woven by an electro-conductive material such as carbon fibers is installed in the dual loop fuel cell (1) and at a position proximate to a side of the hydrogen storage tank (2), and a hydrogen pole output circuit (52) coupled to the carbon cloth is connected to the electron loader (5) through a diode (54) and serves as an output phase of a fuel cell hydrogen catalytic pole. A surface of the carbon cloth constituting the hydrogen catalytic pole is coated with nanocarbon tubes, and the nanocarbon tubes are spluttered with molecular particles of platinum (Pt) or palladium (Pd) serving as a hydrogen fuel contact, a production of protons and a three-contact-point membrane for transmitting electrons. In other words, the nanocarbon tube serves as the hydrogen catalytic pole (22).

In addition, a piece of silver mesh woven by an electro-conductive material such as a silver wire is installed in the dual loop fuel cell (1) and at a position proximate to a side of the carbon dioxide storage tank (3), and a carbon dioxide pole output circuit (51) coupled to the silver mesh is connected to the electron loader (5) through the diode (54) and serves as an output phase of the fuel cell carbon dioxide nanometer (nM) reacting pole (32). A nanometer structure (nM) is coated onto a surface of the silver mesh of the carbon dioxide nanometer (nM) reacting pole (32) and serves as a carbon dioxide, a photo catalysis, a decomposition of carbon and oxygen and a four-contact-point membrane for transmitting electrons. The nanometer structure serves as a place for temporarily binding the C⁴⁺ nM state carbon, which is also the carbon dioxide nanometer (nM) reacting pole (32) of the invention. The light projecting range of the carbon dioxide nanometer (nM) reacting pole (32) projected by the ultraviolet lamp (43) is processed by multiple folding method to maximize the contact and catalytic area of carbon dioxide (CO₂).

The hydrogen control valve (25) installed on the hydrogen connecting pipe (21) at the tip of the hydrogen storage tank (2) is opened, such that hydrogen is passed in and contacted with the hydrogen catalytic pole (22), and the hydrogen at the three-contact points of the hydrogen catalytic pole (22) is decomposed into proton (H⁺) and electron (e⁻). The electron (e⁻) is transmitted by the hydrogen pole output circuit (52) and the diode (54), and coupled with the electron loader (5) and consumed. The proton (H⁺) produced by the decomposition of hydrogen at the three-contact-points membrane is guided into the hydrogen reacting pole (24) and contacted with the contact of oxygen (O₂) decomposed by the carbon dioxide nanometer (nM) reacting pole (32), wherein a reduction reaction is taken place to produce water (H₂O) which is discharged from the water discharge valve (71) through the water discharge pipe (7) at the bottom. Now, the electron (e⁻) produced by the carbon dioxide nanometer (nM) reacting pole (32) is transmitted from the carbon dioxide pole output circuit (51) and the diode (54) and coupled and consumed by the electron loader (5).

The electron loader (5) is used for consuming the electron (e⁻) produced by the carbon dioxide nanometer (nM) reacting pole (32), such that the carbon-oxygen bond of the carbon dioxide loses electron (e⁻) temporarily and thus it is broken, or else carbon dioxide cannot be decomposed into C⁴⁺ nM state carbon and free ionized oxygen.

The proton (H⁺) is contacted with the hydrogen reacting pole (24) through the insulation of the hydrogen pole insulating osmosis membrane (23) and the oxygen molecules insulated through the oxygen pole insulating osmosis membrane (33) for a reverse reduction to produce water which is discharged from the water discharge valve (71) through the water discharge pipe (7). The hydrogen pole insulating osmosis membrane (23) and the oxygen pole insulating osmosis membrane (33) have the function of permeating proton (H⁺) and oxygen molecule (O₂), but it is necessary to keep the free electrons at an insulating state for forming an electron-hole pair, so that the dual loop fuel cell (1) can perform the start-up reaction. More importantly, the electron (e⁻) produced by the carbon dioxide nanometer (nM) reacting pole (32) is consumed to break down the strong bond of carbon dioxide temporarily to achieve the effects of decomposing and recycling carbon dioxide in accordance with the present invention.

The operating method of decomposing carbon dioxide in accordance with the present invention comprises the steps of connecting a power switch (41) installed on a circuit of the power supply device (4) at a close circuit state, such that an electrothermal heater (42) installed on the carbon dioxide nanometer (nM) reacting pole (32) starts heating, while the ultraviolet lamp (43) installed in the dual loop fuel cell (1) starts lighting. If the temperature of the carbon dioxide nanometer (nM) reacting pole (32) rises to 150° C.˜180° C., the hydrogen control valve (25) and the carbon dioxide control valve (34) will be opened, such that hydrogen in the hydrogen storage tank (2) is filled into a side of the hydrogen catalytic pole (22) through the hydrogen connecting pipe (21), while carbon dioxide in the carbon dioxide storage tank (3) is filled into a side proximate to the carbon dioxide nanometer (nM) reacting pole (32).

Now, the high-energy photons emitted from the ultraviolet lamp (43) randomly bombard on carbon dioxide attached on the carbon dioxide nanometer (nM) reacting pole (32), such that electron bonds of carbon dioxide molecules are situated at an excited state due to the absorption of light energy, and the electrons between the strong bond produces a quantum effect due to the jump of energy level, and the carbon-oxygen bond between the carbon dioxide molecules is loosened temporarily, and the ionized oxygen can be reacted with the proton (H⁺) produced by the hydrogen catalytic pole (22) to form water, and the carbon in the carbon dioxide molecules is bound with the nanometer structure (nM) temporarily to form the C⁴⁺ nM state carbon.

If the output capability of the dual loop fuel cell is reduced to a rated 80%, the performance of the carbon dioxide catalytic pole (CO₂ pole) will drop since the nanopores are filled into the C⁴⁺ nM state carbon. It is necessary to perform a second-stage chemical reaction process which is the reduction process of the C⁴⁺ nM state carbon, wherein the static charge generator (6) is used for returning the energy of the four free electrons (4e⁻) to the reverse reaction process of the C⁴⁺ nM state carbon, which is shown in the reduction process C^{4 -} nM+4e⁻↓→C+∇nM of the present invention.

The operating method of reducing C⁴⁺ nM state carbon into carbon in accordance with the present invention comprises the steps of shutting the hydrogen control valve (25), the carbon dioxide control valve (34) and the water discharge valve (71) installed at the bottom, such that the dual loop fuel cell (1) resumes its initial state; disconnecting the power switch (41) on a circuit of the power supply device (4), so that the circuit is disconnected at an open circuit state, and the temperature of the carbon dioxide nanometer (nM) reacting pole (32) drops to 90° C.˜30° C., and the ultraviolet lamp (43) is distinguished due to the disconnected circuit.

With reference to FIG. 2, the static charge generator (6) is turned on, such that the static charge generator (6) can use the principle of generating electricity by friction to produce static electric energy with opposite anode and cathode, wherein the energy with opposite electrons is conducted through the static electricity discharging circuit (61) to guide the four opposite electrons to the tip of an electric comb (63) for discharging electric charge. The principle of using the tip for discharging electricity is adopted for releasing the electric charges into the atmosphere. The four electrons (4e⁻) produced by the static charge generator (6) is transmitted from the static electricity charging circuit (62) to recharge the carbon dioxide nanometer (nM) reacting pole (32), such that the C⁴⁺ nM state carbon temporarily bound with the carbon dioxide nanometer (nM) reacting pole (32) gains the energy of the extra four electrons (4e⁻) to reduce the C⁴⁺ nM state carbon into the carbon atom. Now, the temperature of the carbon dioxide nanometer (nM) reacting pole (32) drops to 90° C.˜30° C. to resume the floppy synaptic state, so that a mechanical force of high-frequency oscillations releases the nanocarbon particles and the carbon dioxide nanometer (nM) reacting pole (32) is heated again to perform another cycle for a reuse.

What is claimed is:

1. A carbon dioxide resolve/decompose and C⁴⁺ nM state carbon recycle device, comprising:
a dual loop fuel cell, containing a hydrogen catalytic pole, a hydrogen pole insulating osmosis membrane, a hydrogen reacting pole, an oxygen pole insulating osmosis membrane, a carbon dioxide nanometer (nM) reacting pole, an electrothermal heater and the ultraviolet lamp;
a hydrogen storage tank, installed at an external side of the dual loop fuel cell, for connecting a hydrogen connecting pipe and a hydrogen control valve;
a carbon dioxide storage tank, installed at an external side of the dual loop fuel cell for connecting a carbon dioxide connecting pipe and a carbon dioxide control valve;
a power supply device, installed at an external side of the dual loop fuel cell for connecting the electrothermal heater and the ultraviolet lamp through a power switch;
an electron loader, installed at an external side of the dual loop fuel cell, and having an end connected to the carbon dioxide nanometer (nM) reacting pole of the dual loop fuel cell by an output circuit and a diode of the carbon dioxide pole, and another end connected to an output circuit and a diode of the hydrogen catalytic pole by an output circuit and a diode of the hydrogen pole and the dual loop fuel cell, and having a common circuit connected to the hydrogen reacting pole of the dual loop fuel cell;
a static charge generator, installed at an external side of the dual loop fuel cell, and having an end connected to a static electricity discharging circuit and an electric comb, and another end connected to a static electricity charging circuit, and the carbon dioxide nanometer (nM) reacting pole of the dual loop fuel cell;
a water discharge pipe, installed under the dual loop fuel cell hydrogen reacting pole, and the water discharge pipe includes a water discharge valve.

2. The carbon dioxide resolve/decompose and C⁴⁺ nM state carbon recycle device of claim 1, wherein the hydrogen catalytic pole includes a carbon cloth surface coated with nanocarbon tubes, and the nanocarbon tube is spluttered with platinum (Pt) or palladium (Pd) molecular particles.

3. The carbon dioxide resolve/decompose and C⁴⁺ nM state carbon recycle device of claim 1, wherein the carbon dioxide nanometer (nM) reacting pole includes a silver mesh surface coated onto a nanometer structure (nM).

4. The carbon dioxide resolve/decompose and C⁴⁺ nM state carbon recycle device of claim 1, wherein the output circuit and the diode of the carbon dioxide pole of the electron loader is connected to the carbon dioxide nanometer (nM) reacting pole of the dual loop fuel cell.

5. The carbon dioxide resolve/decompose and C⁴⁺ nM state carbon recycle device of claim 1, wherein the output circuit and the diode of the hydrogen pole of the electron loader are connected to the hydrogen catalytic pole of the dual loop fuel cell.

6. The carbon dioxide resolve/decompose and C⁴⁺ nM state carbon recycle device of claim 1, wherein the common circuit of the electron loader is connected to the hydrogen reacting pole in the dual loop fuel cell.

7. A carbon dioxide resolve/decompose and C⁴⁺ nM state carbon recycle, and the carbon dioxide resolve/decompose method comprising:
connecting a power supply device installed on a circuit of the carbon dioxide decompose device to a close circuit state, such that an electrothermal heater carbon dioxide nanometer (nM) reacting pole starts heating, while the ultraviolet lamp installed in a dual loop fuel cell starts lighting, and when the temperature of the carbon dioxide nanometer (nM) reacting pole rises to 150° C.˜180° C., a hydrogen control valve and a carbon dioxide control valve are opened, so that hydrogen in a hydrogen storage tank is filled into a side of a hydrogen catalytic pole through a hydrogen connecting pipe, and carbon dioxide in a carbon dioxide storage tank is filled into a side proximate to the carbon dioxide nanometer (nM) reacting pole;
thereby, the ultraviolet lamp emits high-energy photons randomly bombarding and attaching onto electrons at the outer periphery of carbon dioxide molecules on the carbon dioxide nanometer (nM) reacting pole to force the energy level of an electron bond of the carbon dioxide to jump from a base state to an excited state, such that a bonding force between carbon and oxygen atoms is weakened, and four free electrons (4e⁻) of the carbon dioxide are released by opening a quantum tunnel, and the binding force of the bond of the carbon dioxide with four free electrons (4e⁻) lost is weakened to form a C⁴⁺ nM state carbon and an ionized state oxygen (O₂), and an external circuit is provided for forcibly consuming the energy of the four free electrons (4e⁻) deviated from an orbital, and the energy level of the C⁴⁺ nM state carbon is situated at a base state since four free electrons (4e⁻) are lost, and the ionized oxygen (O₂) is bonded due to four protons (H⁺), and an external electronic circuit obtains four free electron (4e⁻) to fill up electric holes to produce water (2H₂O), and the method uses a hydrogen fuel cell to provide the four protons (H⁺) to the carbon dioxide pole to form oxygen (O₂), and the oxygen (O₂) and the four protons (H⁺) are reacted to form water (2H₂O) as shown in the chemical reaction equations:
(H₂ pole) 2H₂→4H⁺+4e⁻
(CO₂ pole) uv+CO₂+ΔnM→C⁴⁺ nM+O₂+4e⁻↑
(H₂O pole) O₂+4H⁺+4e⁻→2H₂O.

8. A resolve/decompose and C⁴⁺ nM state carbon recycle method, characterized in that if the output capability of a dual loop fuel cell is dropped to a rated 80%, the performance of a carbon dioxide pole (CO₂ pole) will be dropped since nanopores are filled up a C⁴⁺ nM state carbon, and it is necessary to perform a second-stage chemical reaction for reducing the C⁴⁺ nM state carbon, wherein a static charge generator is used for returning the energy of four electrons (4e⁻) to a reverse reaction process of the C⁴⁺ nM state carbon with a chemical reaction equation:
C⁴⁺ nM+4e⁻↓→C+∇nM;
and the method of reducing the C⁴⁺ nM state carbon decomposed from the carbon dioxide into carbon comprises the steps of:
closing a hydrogen control valve, a carbon dioxide control valve and a water discharge valve installed at the bottom, such that the dual loop fuel cell resumes its initial state;
disconnecting a power switch installed on a circuit of a power supply device to an open circuit state, such that the temperature of a carbon dioxide nanometer (nM) reacting pole temperature is dropped to 90° C.˜30° C., and a ultraviolet lamp will be extinguished due to the disconnection of electric power;
starting a static charge generator to produce static charges to form opposite positive and negative poles by the principle of generating electricity by friction, wherein the energy with opposite electrons guide four opposite electrons to a tip of an electric comb for discharging static charge through the connection of a static electricity discharging circuit, and the principle of discharging electricity at the tip is used for releasing the electric charges into the atmosphere;
wherein the static electricity charging circuit transmits the four electrons (4e⁻) produced by the static charge generator to fill the energy back to a carbon dioxide nanometer (nM) reacting pole and temporarily binds at a C⁴⁺ nM state carbon of the carbon dioxide nanometer (nM) reacting pole, and since the energy of the additional four electrons (4e⁻) is obtained, the (C⁴⁺ nM) state carbon is reduced to carbon atom, and the temperature of the carbon dioxide nanometer (nM) reacting pole is dropped to 90° C.˜30° C. to resume its floppy synaptic state, and a mechanical force of a high-frequency oscillation is used for releasing nanocarbon particles successfully, and the carbon dioxide nanometer (nM) reacting pole is heated again for performing another cycle for a reuse.
